(19) United States
(12) Patent Application Publication
(10) Pub. No.: US 2011/0064427 A1
(43) Pub. Date: Mar. 17, 2011

(54) Sheet processing device, image forming system, and sheet conveying method

(75) Inventor: Hiroki Yoshida, Aichi (JP)

(73) Assignee: Ricoh Company, Limited

(21) Appl. No.: 12/805,983

(22) Filed: Aug. 27, 2010

(30) Foreign Application Priority Data
Sep. 15, 2009 (JP) 2009-213472

(51) Int. Cl. G03G 15/00

(52) U.S. Cl. 399/21

(57) ABSTRACT

When a sheet processing device is in operation, if any of a paper jam, a motor error, and an open door occur, a sheet-processing-device control unit stops all the loads of the sheet processing device other than the entrance motor. After that, the sheet-processing-device control unit determines whether an entrance sensor detects a sheet remaining in a sheet discharging path. If no sheet is detected, the entrance motor stops in the same manner as the other loads stop. If the entrance sensor detects a sheet, the entrance motor continues driving. When the number of steps of the entrance motor that continues driving increases to a number equal to or more than a predetermined number that corresponds to a sheet position that is accessible by a user from a discharge tray, the entrance motor stops.

### CROSS-REFERENCE TO RELATED APPLICATIONS

The present application claims priority to and incorporates by reference the entire contents of Japanese Patent Application No. 2009-213472 filed in Japan on Sep. 15, 2009.

### BACKGROUND OF THE INVENTION

1. Field of the Invention

The present invention relates to a sheet processing device that receives a sheet-type recording medium (hereinafter, “sheet”) and processes the sheet, an image forming system, such as a copying machine, a printer, a facsimile machine, and a digital MFP, that includes the sheet processing device, and a sheet conveying method used in the sheet processing device or the image forming system.

2. Description of the Related Art

Together with the various needs for image forming apparatuses and high functional image forming apparatuses, sheet processing devices have been developed that can staple and punch copies printed by an image forming apparatus. As the number of available functions increases, the size of the sheet processing device increases and the installation area and the electric-power consumption also increase. This brings the need for space-saving and power-saving image forming apparatuses and space-saving and power-saving sheet processing devices.

A space-saving sheet processing device has limited functions and is designed to use small components arranged closely together so as to reduce the size of the sheet processing device. Moreover, although most sheet processing devices operate as external devices of an image forming apparatus, inner finishers have been developed that are arranged within an inner space of an image forming apparatus that includes a reading unit, a printing unit, and a paper feeding unit.

As the size of a sheet processing device decreases, it is more difficult have a space available to remove jams in the device/apparatus. Therefore, various technologies have been suggested that enable easy jam recovery.

For example, Japanese Patent Application Laid-open 2006-240759 discloses a sheet processing device that includes a sheet processing unit that is slidable with respect to the image forming apparatus. When a jam occurs in the sheet processing unit, the user slides the sheet processing unit, thereby making a space for removing the jam.

Japanese Patent Application Laid-open H5-221582 is well known as a technology that enables easy jam recovery. A sheet processing device disclosed in Japanese Patent Application Laid-open H5-221582 includes a first conveying path A, a second conveying path B, and a switching claw that switches between the first conveying path A and the second conveying path B. A sheet coming from an external device is conveyed inside along either the first conveying path A or the second conveying path B. If a conveyer error occurs when the sheet is conveyed inside along the first conveying path A, the switching claw switches to the second conveying path B so that subsequent sheets are conveyed along the second conveying path B. With this configuration, user actions necessary for jam recovery are reduced to the minimum.

The sheet processing device disclosed in Japanese Patent Application Laid-open 2006-240759 needs a slide rail and a mechanism that separates the sheet processing device into parts and connects the parts; therefore, the sheet processing device includes additional components unrelated to the main function and has a complicated mechanism, which increases manufacturing costs.

The sheet post-processing device disclosed in Japanese Patent Application Laid-open H5-221582 needs at least two conveying paths; therefore, this cannot be realized in a small sheet processing device that has only one conveying path.

### SUMMARY OF THE INVENTION

It is an object of the present invention to provide a device/apparatus that is small but allows, without increasing the manufacturing costs due to additional components and due to having a complicated configuration, a user to easily remove a sheet remaining inside the device/apparatus.

According to an aspect of the present invention, there is provided a sheet processing device including: a conveying unit that conveys a sheet coming from a preceding device; a sheet processing unit that receives the sheet from the conveying unit and processes the sheet in a predetermined manner; a sheet detecting unit that detects a position of the sheet being conveyed; a stacking unit that stacks thereon the sheet or a sheet set including the sheet that has been processed by the sheet processing unit; a sheet-error detecting unit that detects a conveyance error of the sheet being conveyed in accordance with information received from the sheet detecting unit; a load-error detecting unit that detects an error of a load for driving the sheet processing unit and the stacking unit; a jam recovery door that is used to remove any sheet that causes a jam and any remaining sheet from the sheet processing device; a door detecting unit that detects an open/close state of the jam recovery door; and a control unit, wherein when an error is detected by the sheet-error detecting unit and/or the load-error detecting unit or when the jam recovery door is open, if the sheet being conveyed is detected by the sheet detecting unit, the control unit stops a load for driving the conveying unit after the sheet is conveyed a predetermined distance.

According to another aspect of the present invention, there is provided an image forming system including: an image forming apparatus that forms a visible image on a sheet; and the sheet processing device defined above.

According to still another aspect of the present invention, there is provided a sheet conveying method used in a sheet processing device that includes a conveying unit that conveys a sheet coming from a preceding device; a sheet processing unit that receives the sheet from the conveying unit and processes the sheet in a predetermined manner; wherein, when any of a sheet conveyance error, a load error, and an open state of a jam recovery door is detected, if a sheet being conveyed is detected by a sheet detecting unit, stopping a load for driving the conveying unit after the sheet is conveyed a predetermined distance.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of the configuration of an image forming system according to an embodiment of the present invention;

FIG. 2 is a schematic diagram of the configuration of a sheet processing device;

FIG. 3 is a block diagram of the configuration of a control system according to the present embodiment;

FIG. 4 is a schematic diagram that explains a paper-jam recovery method performed by the sheet processing device according to the present embodiment;

FIG. 5 is an enlarged perspective view of a relevant portion of the sheet processing device when staples are filled;

FIG. 6 is a schematic diagram of an example illustrating a sheet remaining in a sheet discharging path of the sheet processing device;

FIG. 7 is a schematic diagram of an example illustrating a sheet remaining at a removable position in the sheet discharging path;

FIG. 8 is a flowchart of a control process according to the present embodiment that is performed when a paper jam or a motor error occurs when the system is running or when a certain door opens during sheet conveyance; and

FIG. 9 is a flowchart of another control process according to the present embodiment that is performed when a paper jam or a motor error occurs when the system is running or when a certain door opens during sheet conveyance.

### DETAILED DESCRIPTION OF THE PREFERRED EMBODIMENTS

The present invention is made to provide an image forming system that includes a small sheet processing device that discharges, for example, copies to an inner space of the image forming system. The image forming system enables easy jam recovery without increasing the manufacturing costs due to additional components or due to having a complicated mechanism. Exemplary embodiments of the present invention are described in detail below with reference to the accompanying drawings.

In the following embodiments, a conveying unit corresponds to a pair of entrance rollers 201 and a pair of discharging rollers 206; a sheet processing unit corresponds to a pair of shift discharging rollers 204, a trailing-edge referential fence 220, a pair of jogger fences (alignment plates) 212, and a stapler 215; a sheet detecting unit corresponds to an entrance sensor 207, a sheet presence/absence sensor 213, and a sheet-set discharging sensor 210; a stacking unit corresponds to a discharge tray 203; a sheer-error detecting unit corresponds to a sheet-error detecting unit 406; a load-error detecting unit corresponds to a load-error detecting unit 407; a jam recovery door corresponds to a jam recovery door 180; a door detecting unit corresponds to a door SW 490; a load corresponds to an entrance motor 216; a control unit corresponds to a CPU 401; a furthest-upstream conveying roller corresponds to the entrance rollers 201; a furthest-downstream conveying roller corresponds to the discharging rollers 206; an image forming apparatus corresponds to an image forming apparatus 100; and a sheet processing device corresponds to a sheet processing device 200.

### General Configuration

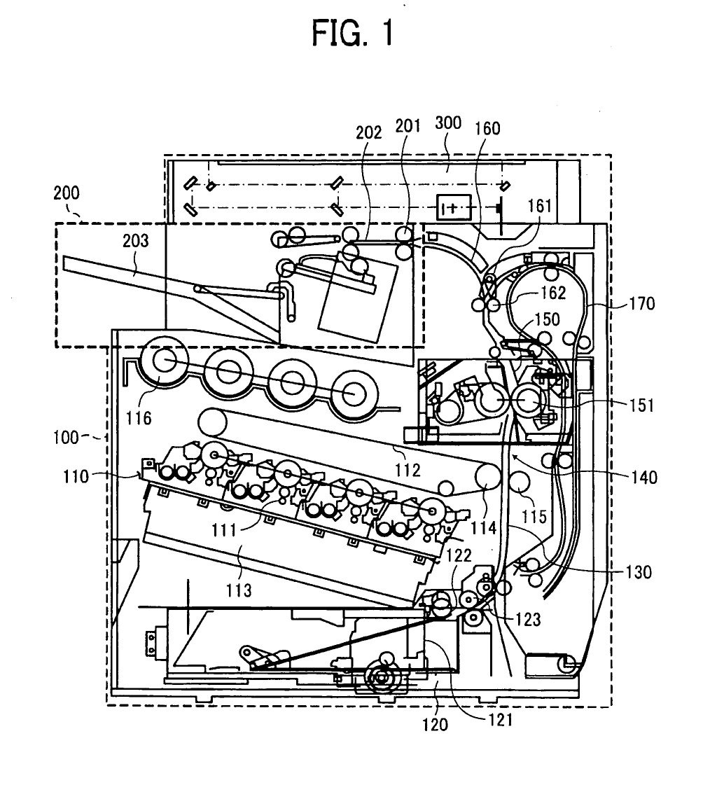

FIG. 1 is a schematic diagram of the configuration of an image forming system according to an embodiment of the present invention. As shown in FIG. 1, the image forming system according to the present embodiment includes an image forming apparatus 100, a sheet processing device 200, and an image reading device 300.

The image forming apparatus 100 is a tandem-type color image forming apparatus that uses an intermediate transfer mechanism. As shown in FIG. 1, the image forming apparatus 100 includes an image forming unit 110 that includes image forming stations 111 for four different colors in the middle; an optical writing unit 113 that is adjacent to the bottom section of the image forming unit 110; a paper feeding unit 120 that is below the optical writing unit 113; a sheet conveying path (vertically conveying path) 130 through which, after a sheet is picked up by the paper feeding unit 120, the sheet is conveyed to an intermediate transferring unit 140 and a fixing unit 150; a sheet discharging path 160 through which the sheet with an image fixed thereto is conveyed toward the sheet processing device 200; and a duplex-printing conveying path 170 that is used to reverse a single-side printed sheet so that another image is formed on the other side of the sheet.

The image forming unit 110 includes drum-shaped photosensitive elements for Y, M, C, and K of the image forming stations. The image forming unit 110 includes, around the outer circumference of each photosensitive element are a charging unit, a developing unit, a primary transferring unit, a cleaning unit, and a neutralizing unit. The image forming unit 110 further includes an intermediate transfer belt 112 that receives images from the photosensitive elements by the primary transferring units and the optical writing unit 113 that writes different color images to the photosensitive elements. The optical writing unit 113 is arranged below the image forming stations 111. The intermediate transfer belt 112 is arranged above the image forming stations 111.

The intermediate transfer belt 112 is rotatably supported by a plurality of supporting rollers that includes a supporting roller 114. The supporting roller 114 faces a secondary transfer roller 115 across the intermediate transfer belt 112 in the secondary transferring unit 140 so that an image is transferred from the intermediate transfer belt 112 onto a sheet during secondary transfer. The reference numeral 116 is a detachable toner container. Image forming processes by tandem-type color image forming apparatuses that use an intermediate transfer mechanism is well known. Such an image forming process is not within a scope of the invention; therefore, any image forming processes will not be described in detail below.

The paper feeding unit 120 includes a paper feed tray 121, a pick-up roller 122, and a sheet conveying roller 123. The paper feeding unit 120 feeds a sheet from the paper feed tray 121 and conveys the sheet upward along the vertically conveying path 130. An image is transferred by the secondary transferring unit 140 onto the sheet coming from the paper feeding unit 120. The sheet is then conveyed to the fixing unit 150. The fixing unit 150 includes a fixing roller 151 and a pressing roller. When the sheet is passing between the fixing roller and the pressing roller, heat and pressure is applied to the sheet and thus the toner image is fixed to the sheet.

The fixing unit 150 includes the fixing roller 151. Downstream of the fixing unit 150 are the sheet discharging path 160 and the duplex-printing conveying path 170, both paths being bifurcated from the same path by operation of a bifurcating claw 161. Either path is selected depending on whether the sheet is to be conveyed to the sheet processing device 200 or the duplex-printing conveying path 170. A bifurcating-point conveying roller 162 is arranged immediately upstream of the bifurcating claw 161 in the sheet conveying direction. The bifurcating-point conveying roller 162 applies to the sheet a power to go forward.

The sheet processing device 200 is in an inner space of the image forming apparatus 100. The sheet processing device 200 processes an image formed sheet that is received from the image forming apparatus 100 in a predetermined manner and stacks the processed sheet on a discharge tray 203 that is arranged furthest downstream. The sheet processing device 200 will be described in detail later.

The image reading device 300 is a well-known reading device that scans an original that is placed on an exposure glass with light, thereby reading an image from the original. The configuration and the function of the image reading device 300 are well-known and not directly related to the scope of the present invention; therefore, the image reading device 300 will not be described in detail below.

The image forming apparatus 100 creates image data in accordance with data containing the image of the original scanned by the image reading device 300 or data containing an image to be printed received from an external. PC. The optical writing unit 113 writes an image to each photosensitive element with light in accordance with the created image data. The image forming stations sequentially transfer the different four color images onto the intermediate transfer belt 112 in a superimposed manner and thus a color image is formed on the intermediate transfer belt 112. A sheet is conveyed from the paper feed tray 121 in accordance with the image formation. The sheet stops at a registration-roller position (not shown) immediately before the intermediate transferring unit 140 and then goes forward at appropriate timing with respect to the leading edge of the image that is formed on the intermediate transfer belt 112. The sheet receives the image by the intermediate transferring unit 140 during secondary transfer and the sheet with the image is conveyed to the fixing unit 150.

After the image is fixed to the sheet by the fixing unit 150, if the single-printing mode is selected or if duplex-printing mode is selected but images are already formed on the both surfaces, by switching operation of the bifurcating claw 161, the sheet is conveyed to the sheet discharging path 160. If the duplex-printing mode is selected, the sheet is conveyed to the duplex-printing conveying path 170. If the sheet is conveyed to the duplex-printing conveying path 170, the sheet is reversed so that the upper side faces downward and then the sheet is conveyed again to the intermediate transferring unit 140. After that, an image is formed on the opposite surface and the sheet is then conveyed to the sheet discharging path 160. After the sheet is conveyed to the sheet discharging path 160, the sheet is conveyed to the sheet processing device 200. The sheet is subjected to predetermined sheet processing by the sheet processing device 200 or passes through the sheet processing device 200 without being subjected to any post-processing. The processed or unprocessed sheet is then discharged onto the discharge tray 203.

### Sheet Processing Device

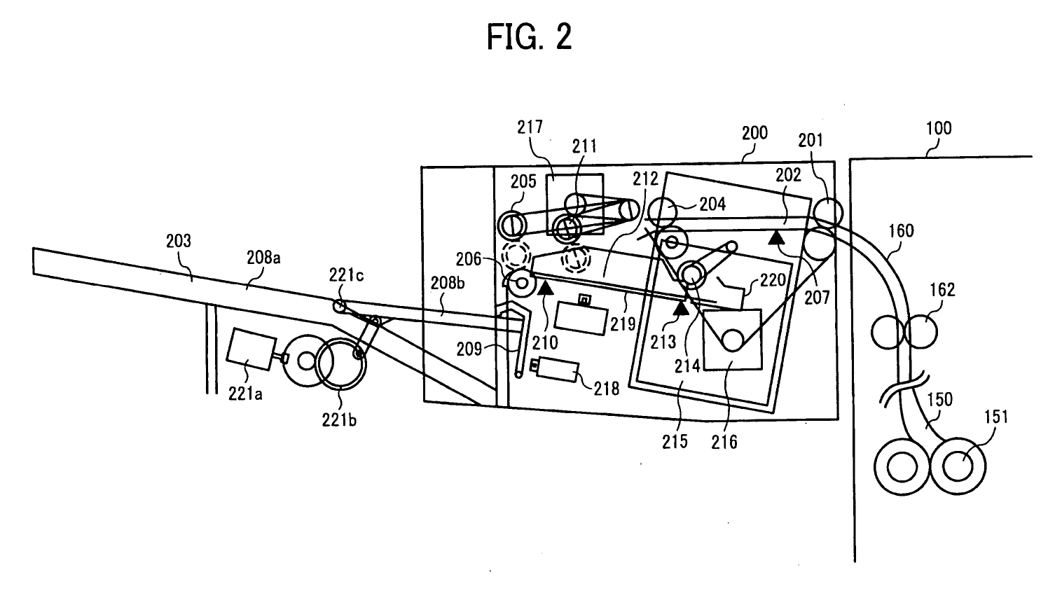

FIG. 2 is a schematic diagram of the configuration of the sheet processing device 200.

As shown in FIG. 2, the sheet processing device 200 includes a pair of entrance rollers 201, a sheet discharging path 202, a pair of shift discharging rollers 204, a staple tray 219, a tapping roller 211, a reverse roller 214, a trailing-edge referential fence 220, a pair of jogger fences (alignment plates) 212, a pair of discharging rollers 206, and the discharge tray 203. These units are arranged in this order with the entrance rollers 201 being furthest upstream in the sheet conveying direction.

A sheet receiving unit of the sheet processing device 200 includes the entrance rollers 201 that receives a sheet from the image forming apparatus 100 through the sheet discharging path 160; the sheet discharging path 202 through which the received sheet is conveyed to the shift discharging rollers 204; and the shift discharging rollers 204 that corresponds to the sheet processing unit that shifts the sheet and discharges the sheet onto the discharge tray 203. By rotation of the entrance rollers 201 and the shift discharging rollers 204 driven by an entrance motor 216, the sheet is conveyed along the sheet discharging path 202.

Near the sheet discharging path 202 is an entrance sensor 207 that detects the leading edge and the trailing edge of a sheet. The operational timing is determined in accordance with the detected timing of the leading edge and the trailing edge of a sheet with respect to the number of driving steps of the entrance motor 216 and the number of driving steps of a later-described discharging motor 217. Both of the entrance motor 216 and the discharging motor 217 are stepping motors.

Both the entrance rollers 201 and the shift discharging rollers 204 that are arranged along the sheet discharging path 202 together work as a conveying unit.

Sheets are discharged in different manners depending on modes. In a shift mode, sheets are shifted and then discharged. In a staple mode, sheets are stapled and the stapled sheet set is then discharged. In the following, the sheet discharging manner is described in each mode.

Shift Mode Operation

In the shift mode, sheets are discharged in a sorted manner that a set of a predetermined number of sheets is stacked at a discharge position that is displaced from a discharge position of another set of sheets in a direction perpendicular to the sheet conveying direction.

The shift discharging rollers 204 are arranged at the downstream end of the sheet discharging path 202. The shift conveying rollers 204 are moved, by a shift motor (not shown), back and forth in the direction perpendicular to the sheet conveying direction. In the shift mode, sheets are discharged onto the discharge tray 203 in a sorted manner by moving, when the last sheet of each set of sheets is discharged, in the direction perpendicular to the sheet conveying direction so that the next set is stacked a certain distance displaced from the position of the current set. As a result, sets of sheets are stacked alternately at the different positions and thus sheets are sorted.

Downstream of the shift discharging rollers 204 are a sheet guiding plate 205 and the discharging rollers 206. The discharging rollers 206 are driven by the discharging motor 217. The sheet guiding plate 205 is movable driven up and down by a stepping motor (not shown). The sheet is conveyed to the discharge tray 203, nipped between the discharging rollers 206 and a driven roller attached to the sheet guiding plate 205, and then stacked on the discharge tray 203.

A sheet holder 209 is at a portion of the discharge tray 203 that is attached to the main body of the sheet processing device 200. The sheet holder 209 holds and release sheets that are stacked on the discharge tray 203 by ON/OFF of a solenoid 218.

The solenoid 218 is switched ON in accordance with sheet conveyance and, in turn, the sheet holder 209 releases the sheets stacked. When the sheet has passed through the discharging rollers 206, the solenoid 218 is switched OFF and, in turn, the sheet holder 209 holds the sheets stacked.

The discharge tray 203 has an unmovable tray section 208a and a movable tray section 208b that is upstream of the unmovable tray section 208a in the sheet conveying direction. The movable tray section 208b is moved up and down by a tray DC motor 221a and a cam/link mechanism. The movable tray section 208b has an upstream rotatable end and is supported via a supporting shaft 221c swingably by the unmovable tray section 208a. The movable tray section 208b is connected to an operational end of a cam/link mechanism 221b. With this configuration, when the tray DC motor 221a rotates, the movable tray section 208b swings around the supporting shaft 221c.

When a predetermined number of sheets are discharged, in response to an instruction received from a later-described control unit, the tray DC motor 221a rotates and, in turn, a free end, namely the upstream rotatable end of the movable tray section 208b moves down. The sheet holder 209 has a surface-of-sheet-on-tray sensor (not shown). If the surface-of-sheet-on-tray sensor is OFF in a situation that the sheet holder 209 holds the sheets, the discharge tray 203 moves up until the surface-of-sheet-on-tray sensor is switched ON. If the surface-of-sheet-on-tray sensor is ON, the discharge tray 203 moves down until the surface-of-sheet-on-tray sensor is switched OFF and then moves up until the surface-of-sheet-on-tray sensor is switched ON, again. With this configuration, the height of the discharge tray 203 with the sheets thereon is maintained at the same level.

As described above, in accordance with the conditions of the sheets stacked on the discharge tray 203, the free end of the movable tray section 208b moves up and down so as to maintain the distance between the nip between the discharging rollers 206 and a sheet stacking section of the movable tray section 208b to the same value, which maintains the angle between a sheet discharged from the discharging rollers 206 and the movable tray section 208b to be the fixed angle, enables accurate alignment of sheets stacked on the discharge tray 203, and enables stack of a large number of sheets on the discharge tray 203.

The above operation is repeated and thus sheets are stacked on the discharge tray 203 in a sorted manner.

Staple Mode Operation

In the staple mode, a set of sheets is stapled by a stapler and the stapled sheet set is then discharged.

Between the shift discharging rollers 204, which is at the downstream end of the sheet discharging path 202, and the sheet guiding plate 205, which is immediately upstream of the discharge tray 203, is the tapping roller 211 that is moved up and down by a stepping motor (not shown). The tapping roller 211 includes a lever section that moves up and down and a roller section. The roller section is rotated by the discharging motor 217 in the direction opposite to the sheet conveying direction.

In the staple mode, when the trailing edge of the sheet has passed through the shift discharging rollers 204, the tapping roller 211 moves down and presses, at the roller section, the staple tray 219 that is a sheet stacking unit. The roller section rotates so that the sheet reverses until the trailing edge of the sheet abuts against the trailing-edge referential fence 220. It is noted that the roller section of the tapping roller 211 is rotated by the discharging motor 217, i.e., the tapping roller 211 and the discharging rollers 206 are rotated by the same motor. The reverse roller 214 is above the trailing-edge referential fence 220. The reverse roller 214 is an auxiliary for reversing the sheet. The reverse roller 214 aligns the sheets in the sheet conveying direction.

The sheets are aligned by abutting against the trailing-edge referential fence 220 with respect to the trailing-edge referential fence 220.

When the sheet reverse operation is completed, the sheets are aligned by the jogger fences 212, which are arranged on the staple tray 219, in the direction perpendicular to the sheet conveying direction. One of the jogger fences 212 is an unmovable member and the other is a movable member. The movable member moves in the direction perpendicular to the sheet conveying direction so as to hold the edges of the sheets with the unmovable member. The jogger fences 212 come into contact with the edges of the sheets, thereby aligning the sheets with respect to a referential position.

During the alignment, a corner of the trailing edge of the sheets is inserted to a staple position of a stapler 215. The stapler 215 corresponds to the sheet processing unit. After receiving a predetermined number of sheets, reversing the sheets, and aligning the sheets, the sheets are stapled. Therefore, in the present embodiment, the trailing-edge referential fence 220 and the jogger fences 212 work together as the sheet processing unit.

After the stapling, as indicated by in the dot line of FIG. 2, the sheet guiding plate 205 moves down and holds the sheet set with the discharging rollers 206 using a driven roller attached to the sheet guiding plate 205. By driving of the discharging motor 217, the sheet set is discharged onto the discharge tray 203. After the elapse of a predetermined number of steps since the start of sheet-set discharging, the solenoid 218 is switched ON and, in turn, the sheet holder 209 releases the sheet set, and the discharge tray 203 further moves down by a certain distance.

After that, when the trailing edge of the sheet set has passed by a sheet-set discharging sensor 210, the sheet guiding plate 205 moves up and then the discharging motor 217 stops so as to receive the next sheet. At the same time, the solenoid 218 is switched OFF to hold sheets. The reference numeral 213 is a sheet presence/absence sensor that is used to determine whether one or more sheets are present on the staple tray 219. This sensor is used at a power-on and during a jam recovery to determine whether any sheet is present in the sheet processing device 200.

### Control Device

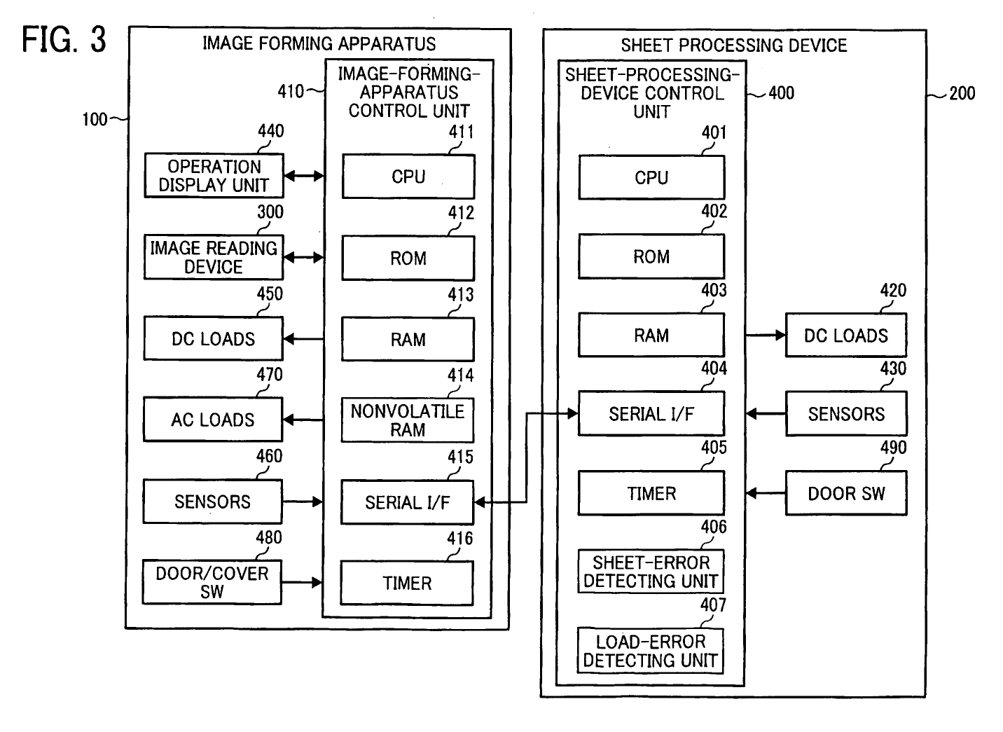

FIG. 3 is a block diagram of the configuration of a control system according to the present embodiment.

The image forming apparatus 100 is controlled by an image-forming-apparatus control unit 410. The image-forming-apparatus control unit 410 includes, as shown in FIG. 3, a CPU 411, a ROM 412, a RAM 413, a nonvolatile RAM 414, a serial I/F 415, a timer 416, etc. Control program codes are stored in the ROM 412. The CPU 411 loads a program code on the RAM 413, stores data necessary for a control process in the RAM 413, and performs the control process in accordance with the program code while using the RAM as a work area.

The image-forming-apparatus control unit 410 is connected to motors that are used for the photosensitive elements or the like of the image forming unit 110, DC loads 450 and AC loads 470 that include motors and clutches that are used for the paper feeding unit 120, the sheet conveying path 130, and the duplex-printing conveying path 170, and sensors 460 that includes a temperature sensor for detecting the temperature of the fixing roller.

The image-forming-apparatus control unit 410 is also connected to the image reading device 300 and an operation display unit 440. The units of the image forming apparatus 100 are under the control of the image-forming-apparatus control unit 410.

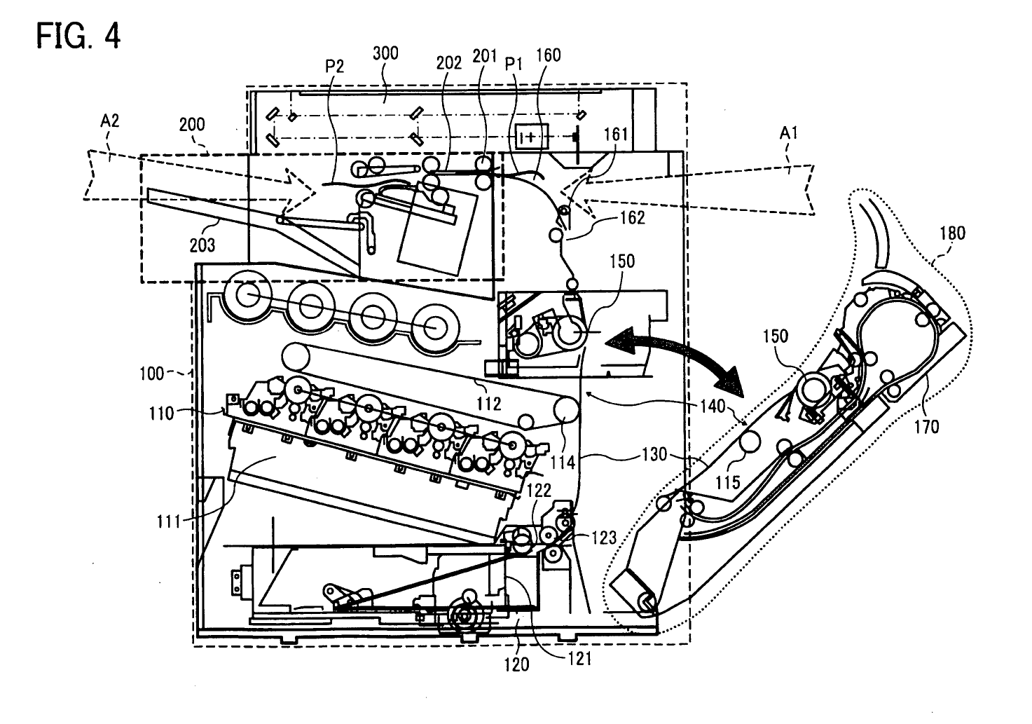

The image-forming-apparatus control unit 410 receives various information, such as information whether a certain cover (not shown) is open and consumables including toners is accessible and information whether a door/cover SW 480 (FIG. 3) indicates that a jam recovery door 180 (FIG. 4) is open for jam recovery maintenance. Although the door/cover SW 480 is not shown in FIG. 4, the door/cover SW 480 operates in accordance with the open/close state of the jam recovery door 180.

The sheet processing device 200 is controlled by a sheet-processing-device control unit 400. The sheet-processing-device control unit 400 includes a CPU 401, a ROM 402, a RAM 403, and a serial I/F 404, a timer 405, etc. Control program codes are stored in the ROM 402. The CPU 401 loads a program code on the RAM 403, stores data necessary for a control process in the RAM 403, and performs the control process in accordance with the program code while using the RAM as a work area. In this manner, the CPU 401 controls DC loads 420 that include the entrance motor 216, the discharging motor 217, the tray DC motor 221a, and the solenoid 218.

The image forming apparatus 100 and the sheet processing device 200 send/receive sheet conveyance commands to/from each other via the serial I/F 415 and the serial I/F 404. The sheet processing device 200 performs sheet conveyance control and post-processing in response to the commands using sheet position information received from sensors 430 that include the entrance sensor 207, the sheet presence/absence sensor 213, and the sheet-set discharging sensor 210.

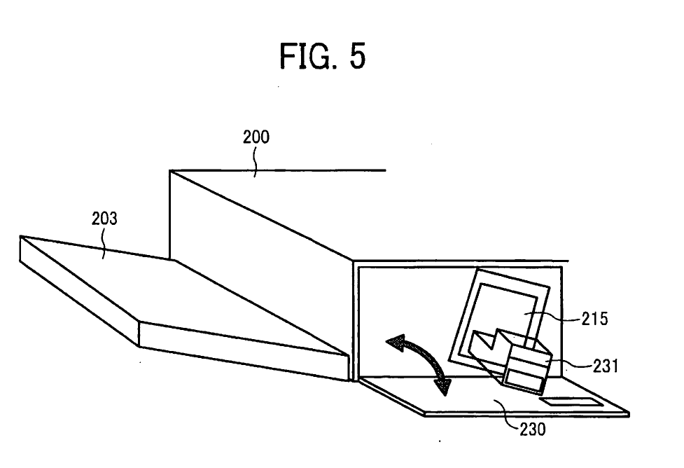

The post-processing-device control unit 400 receives information whether a staple-cartridge replacement door 230 (FIG. 5) is open for filling staples in the stapler 215. The sheet-processing-device control unit 400 further includes a sheet-error detecting unit 406 and a load-error detecting unit 407. The sheet-error detecting unit 406 detects a later-described paper jam, i.e., an error during sheet conveyance. The load-error detecting unit 407 detects a motor error, i.e., an error of any load that is used for driving a sheet processing unit and a stacking unit.

### Paper Jam and Motor Error

When a sheet cannot move forward any more due to a curled portion or a folded portion of the sheet and a device failure and cannot move to the entrance sensor 207 even after a predetermined number of steps of the entrance motor 216, or when a sheet stops at the entrance sensor 207, the sheet-processing-device control unit 400 determines that a paper jam occurs. When a paper jam occurs, the loads including the entrance motor 216 in the sheet processing device 200 stop to stop the sheet conveyance and the post-processing process. Information indicative of occurrence of the paper jam is sent from the sheet-processing-device control unit 400 to the image-forming-apparatus control unit 410 via the serial I/F 404 and the serial I/F 415.

Any motors, for example, the tapping roller 211 other than the entrance motor 216 and the discharging motor 217 that are used for sheet conveyance have home position sensors (not shown). Using information indicative of ON/OFF of the home position sensor and the number of steps of the stepping motor, the stand-by position of the tapping roller 211, the number of driving steps counted from the stand-by position during moving up/down operation, etc., are managed. If the home position sensor is not switched ON or OFF, because of a component failure, still after the tapping roller 211 is driven a predetermined number of steps, the sheet-processing-device control unit 400 determines that a motor error occurs.

When a motor error is detected, in the same manner as in the process in response to a paper jam, the loads in the sheet processing device 200 stop to stop the sheet conveyance and the post-processing process and information indicative of occurrence of the motor error is sent from the sheet-processing-device control unit 400 to the image-forming-apparatus control unit 410 via the serial I/F 404 and the serial I/F 415.

FIG. 4 is a schematic diagram of the image forming system according to the present embodiment that explains, especially, a paper-jam recovery method performed by the sheet processing device 200.

If a paper jam or a motor error occurs near the sheet discharging path 160 of the image forming apparatus 100 or the sheet discharging path 202 of the sheet processing device 200 and motion stops with a sheet remaining inside the sheet processing device 200, the user opens the jam recovery door 180, accesses the sheet (P1) (A1), and removes the sheet. If the user cannot access the sheet from the jam recovery door 180, the user accesses the sheet (P2) (A2) from the discharge tray 203 of the sheet processing device 200 and removes the sheet. It is noted that information indicative of open/close of the jam recovery door 180 is sent from the image-forming-apparatus control unit 410 to the sheet post-processing-device control unit 400 via the serial I/F 415 and the serial I/F 404.

After the sheet is removed, the user closes the jam recovery door 180. After the jam recovery door 180 is closed, if no more sheets remain inside the sheet processing device 200, information about the jam and the motor error is deleted and a certain process is performed for receiving subsequent sheets. Even if the sheet is conveyed appropriately and the motors operate correctly, when the user opens the jam recovery door 180 or the staple-cartridge replacement door 230 when the system is running, in order to prevent an accident caused by access by the user to the units behind the door, the loads in the sheet processing device 200 stop. As shown in FIG. 5 that illustrates an enlarged perspective view of a relevant portion of the sheet processing device 200, when the stapler 215 has no staples, the user opens the staple-cartridge replacement door 230, removes a staple cartridge 231, and fills staples in the staple cartridge 231.

The sheet processing device 200 is arranged in an inner space between the image forming apparatus 100, which includes the image forming unit 110 and the paper feeding unit 120, and the image reading device 300. The upper section of the sheet processing device 200 is adjacent to the image reading device 300, making no space. There are no doors, covers, and similar from which the user can directly access, from above or from the side, the sheet discharging path 202 along which the entrance rollers and the shift discharging rollers 204 are arranged. Therefore, if, because of paper jam or a motor error or because of either door being open during sheet conveyance, motion stops with a sheet remaining inside the sheet processing device 200 in the same manner as described above, depending on the position of the sheet, there is a possibility that it is difficult or impossible to access the sheet from the jam recovery door 180 or the discharge tray 203 of the sheet processing device 200.

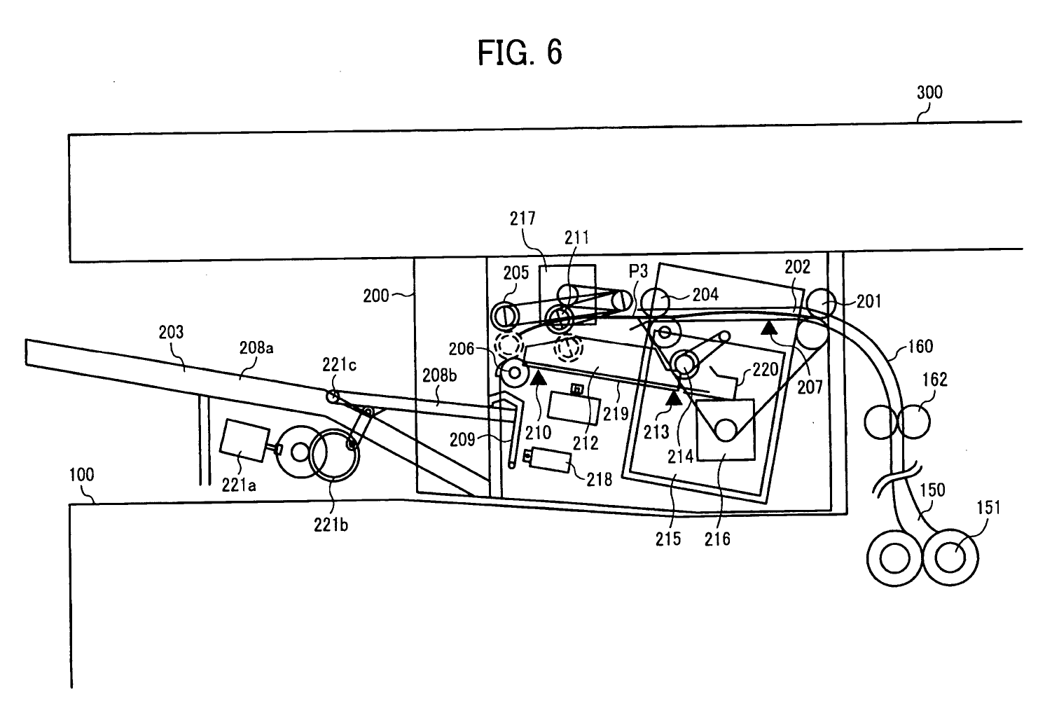

FIG. 6 is a schematic diagram of an example illustrating a sheet remaining in the sheet discharging path 202.

FIG. 6 illustrates the situation where a sheet P3 stops with the leading edge being near the sheet guiding plate 205 and the trailing edge being near the entrance rollers 201, regardless of the reason for stopping the sheet. If the sheet stops at the above position, it is impossible to access the sheet from the jam recovery door 180 of the image forming apparatus 100 and it is difficult to access the sheet from the discharge tray 203 of the sheet processing device 200 because the way is blocked by the sheet guiding plate 205. Moreover, as described above, the upper section of the sheet processing device 200 is adjacent to the image reading device 300 with no space and there are no jam recovery doors, covers, and similar.

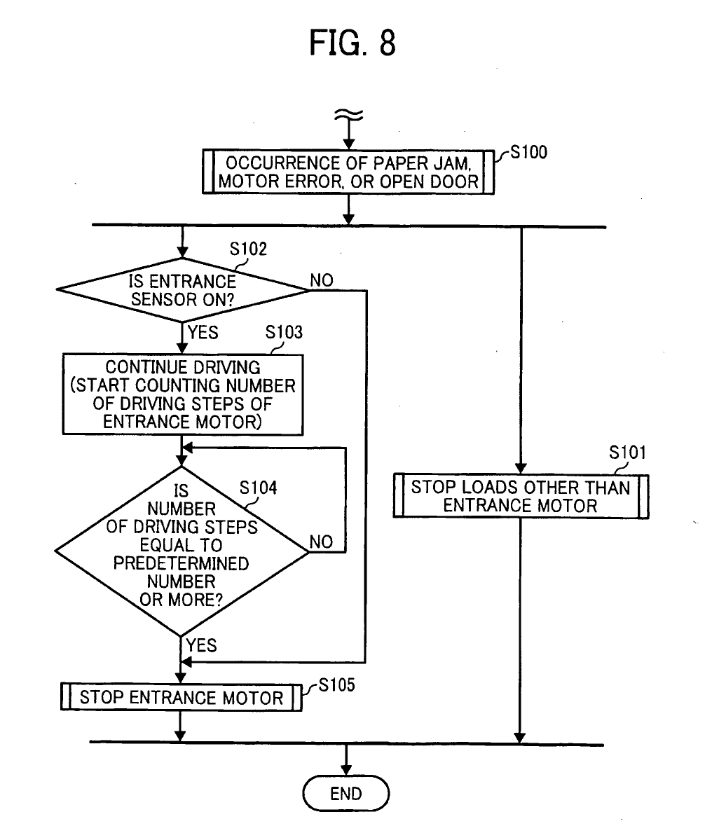

Therefore, in the present, embodiment, the following process is performed to prevent, even when a paper jam or a motor error occurs when the system is running or the door opens during sheet conveyance, a sheet from stopping at the position as shown in FIG. 6. FIG. 8 is a flowchart of the control process.

When a paper jam, a motor error, or an open door occurs in the sheet processing device 200 when the system is running (Step S100), the sheet-processing-device control unit 400 stops all the loads in the sheet processing device 200 except for the entrance motor 216 (Step S101).

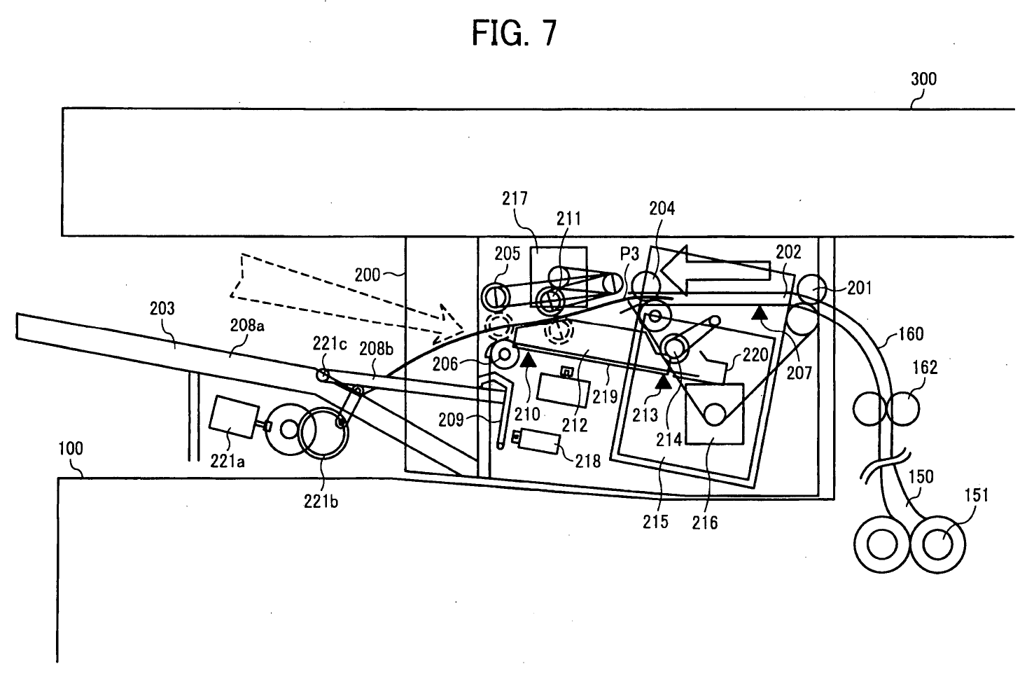

After that, the sheet-processing-device control unit 400 determines the entrance sensor 207 that is arranged at the sheet discharging path 202 detects any sheet (Step S102). If no sheet is detected, the entrance motor 216 stops in the same manner as the other loads stop (Step S105). On the other hand, if the entrance sensor 207 detects any sheet, the entrance motor 216 continues driving (Step S103). When the number of steps of the entrance motor 216 that continues driving increases to a predetermined number or more (Step S104), the entrance motor 216 stops (Step S105). Therefore, the user can access the sheet P3 from the discharge tray 203. FIG. 7 is a schematic diagram of an example illustrating a sheet remaining at a removable position in the sheet discharging path 202.

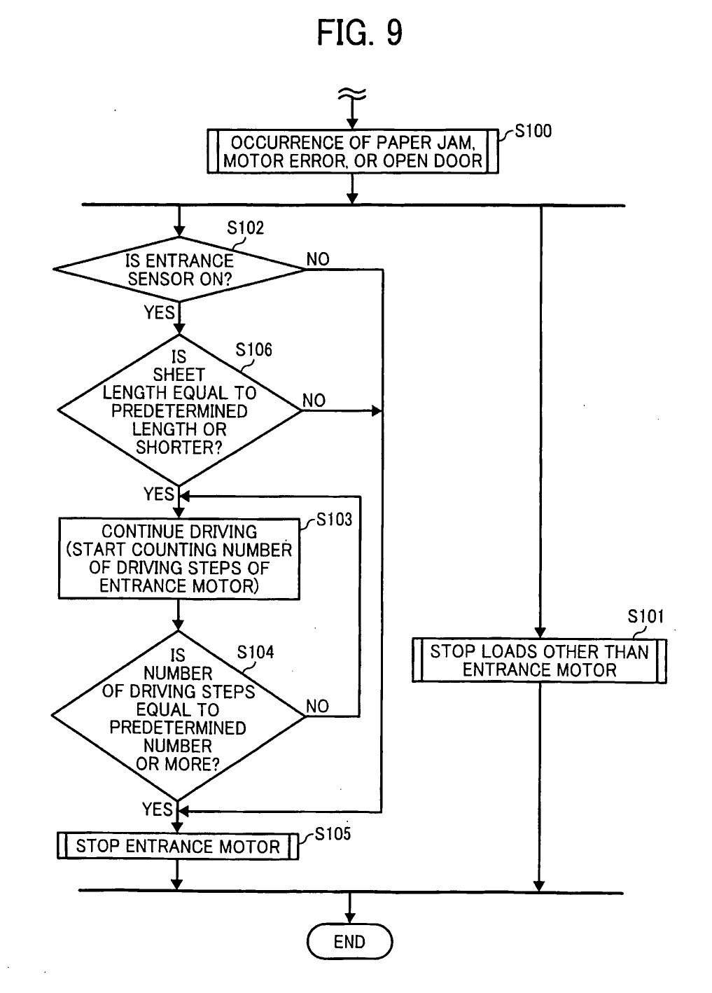

FIG. 9 is a flowchart of another control process that is performed when a paper jam or a motor error occurs when the system is running or when the door opens during sheet conveyance.

When a paper jam, a motor error, or an open door occurs in the sheet processing device 200 when the system is running (Step S100), the sheet-processing-device control unit 400 stops all the loads in the sheet processing device 200 except for the entrance motor 216 (Step S101).

After that, the sheet-processing-device control unit 400 determines whether the entrance sensor 207 that is arranged at the sheet discharging path 202 detects any sheet (Step S102). If no sheet is detected, the entrance motor 216 stops in the same manner as the other loads stop (Step S105).

If the entrance sensor 207 detects any sheet (Yes at Step S102), the sheet-processing-device control unit 400 determines whether the length of the sheet being conveyed is a predetermined length or shorter (Step S106). If the length of the sheet is longer than the predetermined length, the entrance motor 216 stops (Step S105).

On the other hand, if the entrance sensor 207 detects any sheet and the length of the detected sheet is the predetermined length or shorter, the entrance motor 216 continues driving (Step S103). When the number of steps of the entrance motor 216 that continues driving increases to a predetermined number or more (Step S104), the entrance motor 216 stops (Step S105).

The predetermined length used in the determination at Step S106 is equal to the distance between the furthest-upstream roller, i.e., the nip section of the entrance rollers 201 and the furthest-downstream roller, i.e., the nip section of the discharging rollers 206. Alternatively, the predetermined length used in the determination at Step S106 can be the length of a half-letter-size sheet in the longitudinal direction.

The conveying speed at sheet receiving time is needed to be equal to the speed at which the sheet is conveyed from the sheet discharging path 160 of the image forming apparatus 100; therefore, the entrance motor 216 is driven at the driving speed equal to the linear speed at which the sheet is discharged out of the main body. The linear speed control information is sent from the sheet-processing-device control unit 400. After that, when the trailing edge of the sheet has passed through the main-body furthest-downstream roller, namely bifurcating-point conveying roller 162, in order to increase the time allowed for post-processing with maintaining a certain distance away from the next sheet, the sheet conveying speed is increased. In the shift mode, when the sheet is further conveyed and the trailing edge of the sheet has passed through the shift discharging rollers 204, in order to prevent the sheet from going out to the discharge tray 203, the driving speed of the entrance motor 216 is decreased. After that, when the sheet is further conveyed and the trailing edge of the sheet has passed through the discharging rollers 206, the driving speed increases to the linear speed at which the sheet is discharged from the main body so that the next sheet is received smoothly.

In the staple mode, after the trailing edge of the sheet passes through the shift discharging rollers 204, the sheet is conveyed backward and then stacked on the staple tray 219; therefore, before the trailing edge of the sheet has passed through the shift discharging rollers 204, the driving speed of the entrance motor 216 is decreased to a certain linear speed at which the sheet is discharged onto the staple tray.

If, in the flowchart of either FIG. 8 or 9, it is determined the entrance motor 216 continues driving (Step S103), the entrance motor 216 is driven at the speed equal to the latest speed.

As described above, the present embodiment brings the following effects:

1) It is unnecessary to add doors, covers, and similar from which a user accesses the sheet conveying path inside the sheet processing device and a mechanism for sliding the sheet processing device; therefore, any unnecessary increase in the manufacturing costs is suppressed.
2) When an error is detected or when a door opens, if the sheet detecting unit detects a sheet remaining and the length of the detected sheet in the sheet conveying direction is the predetermined length or shorter, the load for driving the conveying unit continues driving so as to convey the sheet a predetermined distance and then the load stops. With this configuration, even a paper jam caused by a short sheet is recoverable.
3) When a sheet stops at a position detectable by the sheet detecting unit, if the sheet is long enough for easy access from the jam recovery door of the image forming apparatus or the discharge tray of the post-processing device, the load for driving the conveying unit stops immediately. With this configuration, unnecessary electric-power consumption is suppressed.
4) When a sheet stops with the leading-edge section at a position detectable by the sheet detecting unit, if the sheet is long enough that the trailing-edge section is still at the fixing roller of the image forming apparatus, the load for driving the conveying unit stops immediately. With this configuration, damage to the fixing roller is prevented that will be caused by the force generated when the load for driving the conveying keeps on driving and the trailing-edge section is pulled out of the fixing roller.
5) The predetermined distance is equal to either the distance between the furthest-upstream conveying roller and the furthest-downstream conveying roller or the length of a half-letter-size sheet in the longitudinal direction; therefore, the sheet is conveyed to a position that allows the user to easily access to the sheet. The user can thus remove the sheet easily.
6) As for the load for driving the conveying unit, the driving speed for conveying the sheet the predetermined distance is equal to the latest driving speed; therefore, a complicated control that changes the conveying speed in a complicated manner is not needed for the sheet processing device.

According to the present invention, a device/apparatus is provided that is small but allows, without increasing the manufacturing costs due to additional components and due to having a complicated configuration, a user to easily remove a sheet remaining inside the device/apparatus.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A sheet processing device comprising:
a conveying unit that conveys a sheet coming from a preceding device;
a sheet processing unit that receives the sheet from the conveying unit and processes the sheet in a predetermined manner;
a sheet detecting unit that detects a position of the sheet being conveyed;
a stacking unit that stacks thereon the sheet or a sheet set including the sheet that has been processed by the sheet processing unit;
a sheet-error detecting unit that detects a conveyance error of the sheet being conveyed in accordance with information received from the sheet detecting unit;
a load-error detecting unit that detects an error of a load for driving the sheet processing unit and the stacking unit;
a jam recovery door that is used to remove any sheet that causes a jam and any remaining sheet from the sheet processing device;
a door detecting unit that detects an open/close state of the jam recovery door; and
a control unit, wherein when an error is detected by the sheet-error detecting unit and/or the load-error detecting unit or when the jam recovery door is open, if the sheet being conveyed is detected by the sheet detecting unit, the control unit stops a load for driving the conveying unit after the sheet is conveyed a predetermined distance.

2. The sheet processing device according to claim 1, wherein if the length of the sheet detected by the sheet detecting unit, in a sheet conveying direction, is longer than a predetermined length or shorter, the control unit causes the load for driving the conveying unit to continue driving so as to convey the sheet the predetermined distance and then stops the load.

3. The sheet processing device according to claim 1, wherein the predetermined distance is a distance between a conveying roller being furthest upstream and a conveying roller being furthest downstream.

4. The sheet processing device according to claim 1, wherein the predetermined distance is a length of a half-letter-size sheet in a longitudinal direction.

5. The sheet processing device according to claim 1, wherein a driving speed of the conveying unit for conveying the sheet the predetermined distance is equal to a latest driving speed.

6. An image forming system comprising:
an image forming apparatus that forms a visible image on a sheet; and
a sheet processing device;
the sheet processing device comprising:
a conveying unit that conveys a sheet coming from a preceding device;
a sheet processing unit that receives the sheet from the conveying unit and processes the sheet in a predetermined manner;
a sheet detecting unit that detects a position of the sheet being conveyed;
a stacking unit that stacks thereon the sheet or a sheet set including the sheet that has been processed by the sheet processing unit;
a sheet-error detecting unit that detects a conveyance error of the sheet being conveyed in accordance with information received from the sheet detecting unit;
a load-error detecting unit that detects an error of a load for driving the sheet processing unit and the stacking unit;
a jam recovery door that is used to remove any sheet that causes a jam and any remaining sheet from the sheet processing device;
a door detecting unit that detects an open/close state of the jam recovery door; and
a control unit, wherein when an error is detected by the sheet-error detecting unit and/or the load-error detecting unit or when the jam recovery door is open, if the sheet being conveyed is detected by the sheet detecting unit, the control unit stops a load for driving the conveying unit after the sheet is conveyed a predetermined distance.

7. The image forming system according to claim 6, wherein the sheet processing device is arranged within an inner space of the image forming apparatus.

8. A sheet conveying method used in a sheet processing device that includes
a conveying unit that conveys a sheet coming from a preceding device;
a sheet processing unit that receives the sheet from the conveying unit and processes the sheet in a predetermined manner;
wherein, when any of a sheet conveyance error, a load error, and an open state of a jam recovery door is detected, if a sheet being conveyed is detected by a sheet detecting unit, stopping a load for driving the conveying unit after the sheet is conveyed a predetermined distance.
